(19) United States
(12) Patent Application Publication
(10) Pub. No.: US 2023/0168460 A1
(43) Pub. Date: Jun. 1, 2023

(54) LIQUID LENS DEVICE PACKAGING AND INTERCONNECTION CONFIGURATIONS

(71) Applicant: CORNING INCORPORATED, CORNING, NY (US)

(72) Inventors: Jerome René Broutin, Bilieu (FR); Benjamin Adrien Lafaverges, Grigny (FR)

(21) Appl. No.: 17/920,949

(22) PCT Filed: Apr. 21, 2021
(86) PCT No.: PCT/US2021/028332

§ 371 Date: Oct. 24, 2022

Related U.S. Application Data
(60) Provisional application No. 63/015,026, filed on Apr. 24, 2020.

(51) Int. Cl. G02B 7/02; G02B 3/14; G02B 26/00

(52) U.S. Cl. CPC G02B 7/02; G02B 3/14; G02B 26/005

(57) ABSTRACT

A liquid lens device with a liquid lens that comprises: first and second immiscible fluids defining an interface moveable by electrowetting, cap and base portions, a gasket positioned between the cap and base portions, an upper window positioned within the base portion, and a lower window positioned within the base portion. The windows are facing and substantially parallel to each other and the fluids are sealed within the cap and base portions, gasket and windows. The device further includes a flexible printed circuit or printed circuit board comprising top and bottom electrodes in electrical contact with the respective cap and base portions of the liquid lens; and a spring washer comprising a substantially circular-shaped body. Further, the spring washer is configured to apply a clamping force of 1 to 10 N between (a) the top electrode and the cap portion, and (b) the bottom electrode and the base portion.

### CROSS-REFERENCE TO RELATED APPLICATIONS

This application claims the benefit of priority under 35 U.S.C. § 371 of International Application No. PCT/US2021/028332, filed on Apr. 21, 2021, which claims the benefit of priority under 35 U.S.C. § 119 of U.S. Provisional Application No. 63/015,026, filed Apr. 24, 2020, the contents of each of which are incorporated herein by reference in its entireties.

### FIELD OF THE DISCLOSURE

The disclosure relates to liquid lens devices and, more particularly, to packaging and interconnection configurations for these devices.

### BACKGROUND

Liquid lenses generally include two fluids disposed within a chamber. Varying an electric field applied to the fluids can vary the wettability of one of the fluids relative to walls of the chamber, which has the effect of varying the shape of a meniscus formed between the two liquids. Further, in various applications, changes to the shape of the meniscus can drive controlled changes to the focal length of the lens.

Many of these liquid lenses are autofocus lenses where a voltage application leads to a change of the focal distance. Such liquid lenses can be used in cell phones and a range of other applications, including barcode readers, surveillance and traffic cameras, along with medical applications. In general, these lenses are compact in size, robust in design and respond quickly enough to remove hand jitter artifacts. Reliability of these liquid lenses for these applications is usually good, as they generally possess a shelf life of several years within the product without experiencing failure or performance degradation.

Emerging applications for liquid lenses include automotive, industrial and other applications with demanding thermal and mechanical environments. Because of the increasing resolution of image sensors and the need for optics with low depth of field, the demand for variable focus optics with high precision and very high stability over a high lifetime is growing. These demands are especially prevalent in open loop applications where the focus is driven within only one iteration by a measurement of the temperature, the working distance, and a look up table. Ultimately, the response of the liquid lenses under these conditions is sensitive to mechanical stress, particularly as integrated within an optical system operating over a large range of temperature. Conventional integration approaches for mechanical and electrical connections typically rely on multiple parts which can drive high assembly costs and/or lead to reliability problems.

Accordingly, there is a need for packaging and interconnections for liquid lens devices that achieve optical performance over a long lifetime of demanding mechanical and thermal environments, and with relatively low assembly and manufacturing cost.

### SUMMARY OF THE DISCLOSURE

According to some aspects of the present disclosure, a liquid lens device is provided that includes a liquid lens that comprises: first and second immiscible fluids defining an interface moveable by electrowetting, a cap portion, a base portion, a gasket positioned between the cap portion and the base portion, an upper window positioned within the cap portion, and a lower window positioned within the base portion, wherein the windows are facing and substantially parallel to each other and the fluids are sealed within the cap portion, base portion, gasket and windows. The liquid lens device also includes: a flexible printed circuit (FPC) or a printed circuit board (PCB) comprising a top electrode and a bottom electrode in electrical contact with the respective cap portion and base portion of the liquid lens; and a spring washer comprising a substantially circular-shaped body. The spring washer is configured to apply a clamping force between (a) the top electrode and the cap portion of the liquid lens, and (b) the bottom electrode and the base portion of the liquid lens. Further, the clamping force of the spring washer is from about 1 N to about 10 N

In embodiments of the foregoing aspects, the liquid lens device further includes a housing in contact with the FPC or PCB and, optionally, one or both of the cap portion and the base portion of the liquid lens. Further, the spring washer configured to secure the housing to one or both of the cap portion and the base portion of the liquid lens.

According to other aspects of the present disclosure, a liquid lens device is provided that includes a liquid lens that comprises: first and second immiscible fluids defining an interface moveable by electrowetting, a cap portion, a base portion, a gasket positioned between the cap portion and the base portion, an upper window positioned within the cap portion, and a lower window positioned within the base portion, wherein the windows are facing and substantially parallel to each other and the fluids are sealed within the cap portion, base portion, gasket and windows. The liquid lens device also includes: a flexible printed circuit (FPC) comprising a top electrode and a bottom electrode, wherein the bottom electrode is in contact with the base portion of the liquid lens; a housing in contact with one or both of the base portion and the cap portion of the liquid lens, wherein the top electrode of the FPC is in contact with a top electrode contact portion of the housing; and a spring washer comprising a substantially circular-shaped body made from an electrically conductive material. The spring washer is configured to apply a clamping force between (a) the top electrode and the top electrode contact portion of the housing, and (b) the bottom electrode and the base portion of the liquid lens. The clamping force of the spring washer is from about 1 N to about 10 N. In addition, the spring washer is configured to secure the housing to one or both of the cap portion and the base portion of the liquid lens and maintain an electrical connection between the cap portion of the liquid lens and the top electrode contact portion of the housing.

According to further aspects of the present disclosure, a liquid lens device is provided that includes a liquid lens that comprises: first and second immiscible fluids defining an interface moveable by electrowetting, a cap portion, a base portion, a gasket positioned between the cap portion and the base portion, an upper window positioned within the cap portion, and a lower window positioned within the base portion, wherein the windows are facing and substantially parallel to each other and the fluids are sealed within the cap portion, base portion, gasket and windows. The liquid lens device also includes: a flexible printed circuit (FPC) comprising a top electrode and a bottom electrode, wherein the bottom electrode is in contact with the base portion of the liquid lens; a housing in contact with one or both of the base portion and the cap portion of the liquid lens; and a spring washer comprising a substantially circular-shaped body made from an electrically conductive material. The top electrode of the FPC is in contact with the spring washer. Further, the spring washer is configured to apply a clamping force between (a) the top electrode and the housing, and (b) the bottom electrode and the base portion of the liquid lens. The clamping force of the spring washer is from about 1 N to about 10 N. In addition, the spring washer is configured to secure the housing to one or both of the cap portion and the base portion of the liquid lens and maintain an electrical connection between the cap portion of the liquid lens and the top electrode of the FPC.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a schematic, cross-sectional view of a liquid lens, according to an embodiment of the disclosure;

FIG. 2A is a schematic, exploded perspective view of a liquid lens device with a flexible printed circuit (FPC) and a spring washer with a plurality of waves, according to an embodiment of the disclosure;

FIG. 2B is a schematic, perspective view of the liquid lens device depicted in FIG. 2A;

FIGS. 2C and 2D are schematic, perspective views of the FPC employed in the liquid lens device depicted in FIGS. 2A and 2B;

FIG. 3A is a schematic, perspective view of a spring washer with a plurality of waves, according to an embodiment of the disclosure;

FIGS. 3B and 3C are schematic views of the spring washer employed in the liquid lens device depicted in FIGS. 2A and 2B, according to an embodiment of the disclosure;

FIGS. 4A and 4B are schematic, perspective views of spring washers with a plurality of waves, according to embodiments of the disclosure;

FIG. 5 is a schematic, perspective view of a liquid lens device with a printed circuit board (PCB) and a spring washer with a plurality of waves, according to an embodiment of the disclosure;

FIGS. 6A and 6B are schematic, exploded perspective views of a liquid lens device with an FPC and a spring washer with a plurality of waves, according to an embodiment of the disclosure;

FIGS. 6C and 6D are schematic, perspective views of the FPC employed in the liquid lens device of FIGS. 6A and 6B, according to an embodiment of the disclosure;

FIGS. 7A and 7B are schematic, exploded perspective views of a liquid lens device with an FPC and a spring washer with a plurality of waves, according to an embodiment of the disclosure;

FIGS. 7C and 7D are schematic, perspective views of the FPC employed in the liquid lens device of FIGS. 7A and 7B, according to an embodiment of the disclosure; and

FIGS. 8A and 8B are schematic plots of spring body compression force vs. spring washer post-compression amplitude of each of its waves, as employed in liquid lens devices, according to embodiments of the disclosure.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an” mean “at least one,” and should not be limited to “only one” unless explicitly indicated to the contrary. Thus, for example, reference to “a component” includes embodiments having two or more such components unless the context clearly indicates otherwise.

The liquid lens devices of the disclosure are generally configured with a liquid lens that includes first and second immiscible fluids that define an interface which is moveable by electrowetting, a cap portion, a base portion, a lower window within the base portion, an upper window within the cap portion, and a gasket positioned between the cap and base portions, among other features. Further, the fluids are sealed within the cap portion, base portion, gasket and windows. In addition, the liquid lens devices include an FPC or a PCB with a top and a bottom electrode that are in electrical contact with the respective cap and base portions of the liquid lens. The liquid lens devices also include a substantially circular-shaped spring washer that applies a clamping force between the electrodes and the respective cap and base portions of the liquid lens. The devices can also include a housing in contact with the FPC or PCB and one or both of the cap and base portions of the lens. In some embodiments of these liquid lens devices, the spring washer has a body that includes a plurality of waves in the thickness direction of the washer. In some embodiments, the FPC is arranged within the liquid lens such that its top and bottom electrodes are not folded around the liquid lens device; rather, at least one of the electrodes of the FPC is connected through the spring washer and/or housing to one of the cap and base portions of the liquid lens.

The liquid lens devices detailed in this disclosure can enable, or otherwise positively influence, the achievement of various technical requirements and performance aspects of devices employing the implementations of these liquid lenses. The liquid lens devices of the disclosure can provide one or more of the following benefits or advantages. For example, the liquid lens devices that employ the spring washer of the disclosure achieve cost and performance advantages over conventional designs. As for cost, the liquid lens devices of the disclosure employ less parts and less manufacturing steps, as the use of the spring washer enables the elimination of multiple parts in conventional designs that perform the same function (e.g., silicone O-ring and a metal clip, silicone O-ring and threaded top cap, etc.). In terms of performance, the use of the spring washer in the liquid lens devices of the disclosure can avoid plastic deformation over a larger temperature range (e.g., −50° C. to +150° C.) as compared to conventional designs, with more repeatable and controllable compression forces. Notably, conventional designs that employ silicone O-rings can be limited by the material properties of the silicone. That is, the O-rings employed in conventional liquid lens devices can plastically deform (e.g., tear) or crack at or near the respective high and low temperature endpoints of some of the more demanding applications for the liquid lens devices contemplated by this disclosure. In addition, the reduction in the number of parts afforded by these liquid lens device configurations can result in weight savings, which can enable applications with more demanding acceleration forces (e.g., automotive applications).

In addition, the liquid lens devices that employ the FPC configurations of the disclosure also offer cost and performance advantages over conventional designs. As each of these liquid lens device configurations may not require a step of folding the top and bottom electrodes of the FPC over the liquid lens, as in conventional designs, manufacturing costs for the liquid lens devices can be reduced. Further, these liquid lens devices can employ FPCs that do not require any ligament or additional material between the top and bottom electrodes for purposes of facilitating a folding operation over the liquid lens, which can enable lower material costs and some weight savings. From a performance standpoint, these liquid lens device configurations are expected to possess higher reliability levels as compared to conventional designs with folded FPCs, as the fold in these FPCs can serve as a site for premature fatigue-related failures. In addition, these liquid lens device configurations have a slightly shorter stack height as the FPC is inserted between the liquid lens and the housing, rather than being folded over the cap and base portions of the liquid lens. With shorter stack heights, these liquid lens device designs can employ lower spring compression forces, which can also improve mechanical performance and reliability.

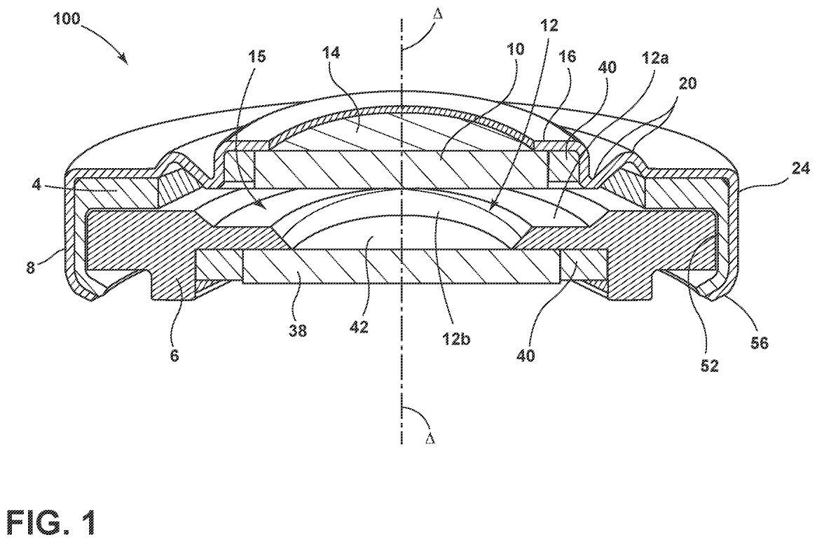

Referring to FIG. 1, a liquid lens 100 is provided that can be configured with a variable focal length. The liquid lens 100 includes first and second immiscible fluids 12a, 12b that define an interface 12 which is moveable by electrowetting. The liquid lens 100 also includes: a cap portion 8; a base portion 6; and a gasket 4 positioned between the cap portion 8 and the base portion 6. Further, the lens 100 includes: an upper window 10 positioned within the cap portion 8; and a lower window 38 positioned within the base portion 6, the windows 10, 38 facing and substantially parallel to each other. The lower window 38 can be joined to the base portion 6 with an adhesive 40 (e.g., a thermoset polymer adhesive or a thermoplastic adhesive), as depicted in exemplary form in FIG. 1 The first and second immiscible fluids 12a, 12b are sealed within the cap portion 8, base portion 6, gasket 4 and windows 10, 38. In some implementations, the lower window 38 is configured with a diameter of at least 4 mm, 5 mm, 7.5 mm, or up to about 10 mm.

Referring again to FIG. 1, the liquid lens 100 can include an upper part and a lower part which are produced separately from one another and which, when assembled, define an internal volume 15 containing the first and second immiscible fluids 12a, 12b. The terms “upper” and “lower” are with reference to the drawings only, inasmuch as the liquid lens 100 can take any orientation during use. A cylindrical member, such as a lower window 38 made of a transparent material, for example, a glass, covers an opening 42 by being interposed between the internal volume 15 of the lens 100 and the opening 42, and is fixed to a base portion 6 by an adhesive 40.

The upper part of the liquid lens 100 comprises the cap portion 8, through the central part of which passes a cylindrical opening 14 and which is extended by a cylindrical side wall 24, the diameter of which is greater than the diameter of a cylindrical wall 52 of the base portion 6. The cap portion 8 comprises an elastic portion 20 provided between the opening 14 and the cylindrical side wall 24. Further, the elastic portion 20 can consist of a wavy portion that exhibits symmetry of revolution about an optical axis (A) and of which the cross section on a plane containing the optical axis (A) has the shape (approximately) of an “S”.

Referring to FIG. 1, the upper window 10, made of a transparent material, for example, a glass, covers the opening 14, by being interposed between the opening 14 and the internal volume 15 of the liquid lens 100, and is fixed to the cap portion 8 by adhesive 40. Advantageously, the cap portion 8 comprises an upper wall 16 connected to the upper window 10 and the cylindrical side wall 24, and the upper wall 16 includes the elastic portion 20 with symmetry of revolution about the optical axis (A) of the liquid lens 100. For example, the cap portion 8 can be made of a stamped metal, e.g., stainless steel. The thickness of the upper wall 16 of the cap portion 8 will depend on the expected variations of volume to compensate for the effects of expansion of the first and second immiscible fluids 12a, 12b. For example, a typical thickness of about 0.1 to 0.25 mm has shown good results for liquid lenses whose outer diameter is below about 20 mm.

As shown in FIG. 1, the liquid lens 100 comprises an upper window 10 and a lower window 38 that face and are parallel to one another. The two windows 10, 38 delimit, at least in part, an internal volume 15 containing the first and second immiscible fluids 12a, 12b, with different optical indices, defining an interface 12. As shown, the windows 10, 38 are plates made from an optically transparent material, e.g., a glass. According to a variant, at least one of the windows 10, 38 can be a lens of fixed optical length, centered on the optical axis (A) of the variable focus lens.

As also shown in FIG. 1, the liquid lens 100 comprises a cap portion 8 connected to upper window 10, which comprises a first cylindrical side wall 24. The device also comprises the base portion 6, preferably having a symmetry of revolution, with the axis of revolution defining the optical axis (A) of the lens. The base portion 6 is connected to the lower window 38 and comprises a second cylindrical side wall 52 of a diameter smaller than the diameter of the first cylindrical wall 24. Further, the upper electrode of the liquid lens 100 comprises the cap portion 8, and the lower electrode of the lens 100 comprises the base portion 6. The gasket 4 is provided to ensure the tightness of the components of the liquid lens 100. In implementations of the liquid lens 100, the gasket 4 is compressed between the first and second cylindrical side walls 24, 52.

According to the embodiment of the liquid lens 100 shown in FIG. 1, the lens 100 further includes a cap portion 8 with an elastic portion 20, which is capable of deforming in response to a change in pressure of the first and second fluids 12a, 12b. In this embodiment, elastic portion 20 is formed on an upper wall of the cap portion 8 in a bent configuration, where the non-linear portions have symmetry of revolution about the optical axis (A) of the lens. For example, the bent aspect of the elastic portion 20 can include at least one arcuate, preferably circular, bend centered on the optical axis (A) of the lens. In some embodiments, the cap portion 8 can preferably be made of a stamped metal, e.g., stainless steel. The thickness of the upper wall 16 of the cap portion 8 will depend on the expected variations within the defined volume 15, in order to compensate for the effects of expansion of the first and second immiscible fluids 12a, 12b. For example, a typical thickness of about 0.1 to 0.25 mm for the upper wall 16 has shown good results for lenses 100 whose outer diameter is below about 20 mm.

Referring again to the liquid lens 100 shown in FIG. 1, the first side wall 24 comprises a rim 56 crimped onto the base portion 6 for sealing the cap portion 8 onto the gasket 4 and the base portion 6. Other methods for sealing the cap portion 8 onto the base portion 6 are also possible; for example, the cap portion 8 can be glued onto the base portion 6 and/or the gasket 4.

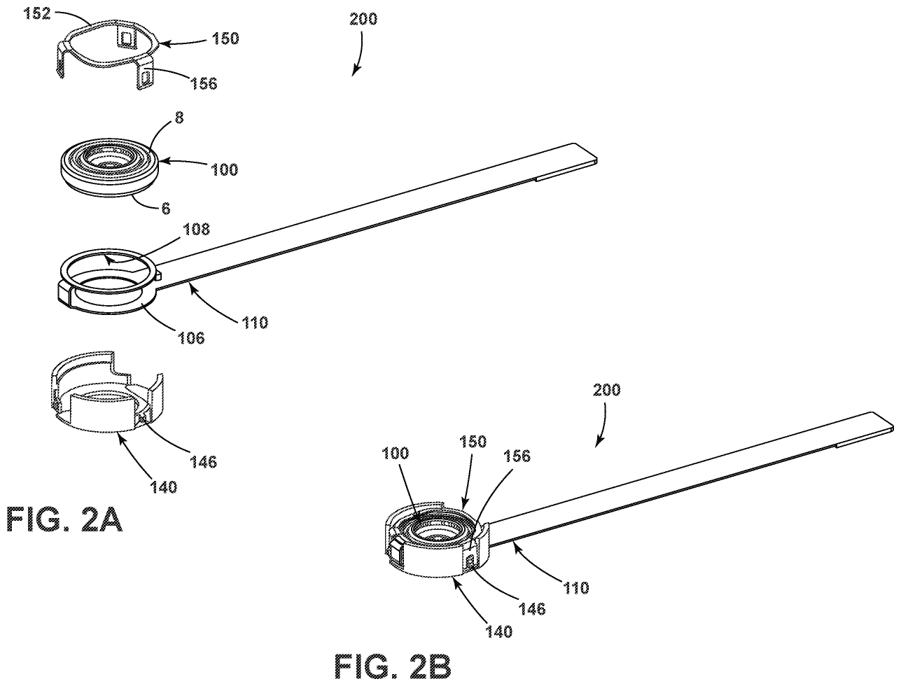

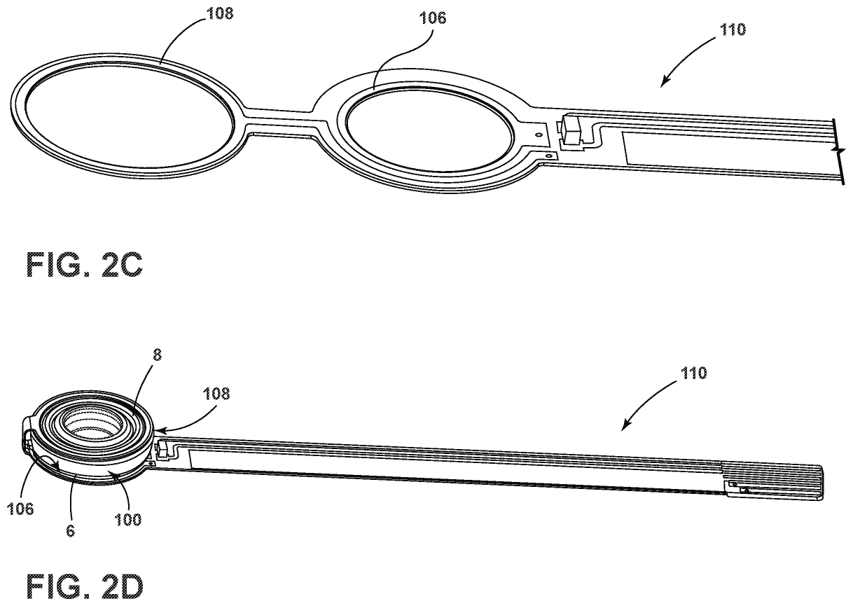

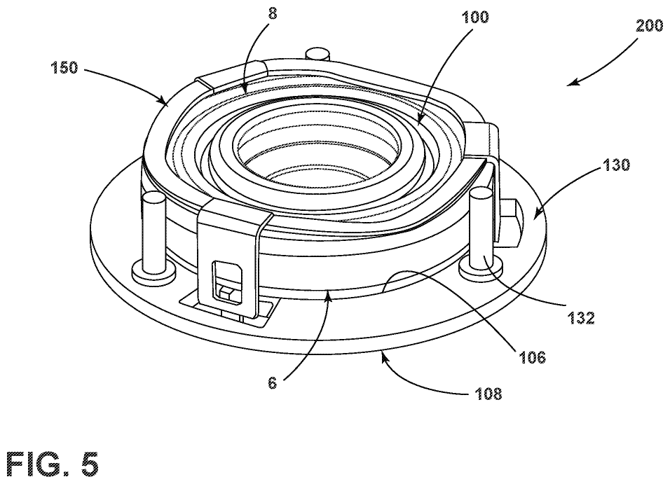

Referring now to FIGS. 2A and 2B, schematic views of a liquid lens device 200 are provided according to embodiments of the disclosure. As shown in these figures, the liquid lens device 200 employs a liquid lens 100, as shown in FIG. 1 and described above. Further, the liquid lens device 200 includes a flexible printed circuit (FPC) 110 (as shown, see also FIGS. 2C and 2D) or a printed circuit board (PCB) 130 (see FIG. 5), as comprising a top electrode 108 and a bottom electrode 106. Further, the top electrode 108 is in electrical contact with the cap portion 8 of the liquid lens 100 and the bottom electrode 106 is in electrical contact with the base portion 6 of the liquid lens 100. In some implementations, these electrical contacts are made by direct physical contact between one or more of the electrodes 106, 108 of the FPC 110 or the PCB 130 (see FIG. 5) and the respective cap and base portions 8, 6 of the liquid lens 100. In other implementations, these electrical contacts are made by one or more intervening electrically conductive components (e.g., a housing 140 and/or spring washer 150).

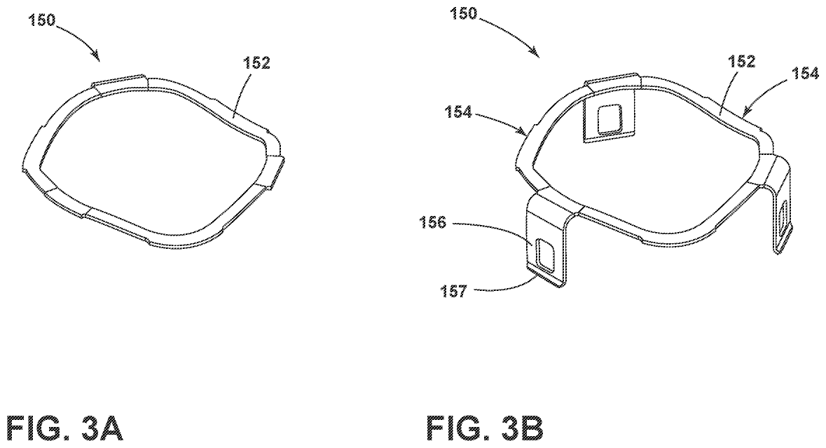

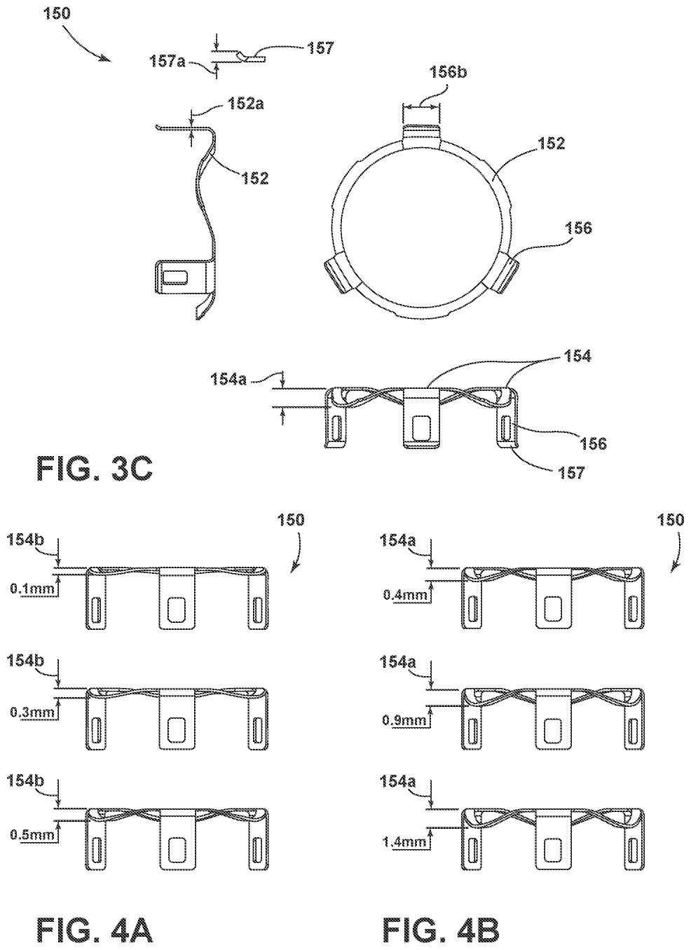

Still referring to FIGS. 2A and 2B, the liquid lens device 200 includes a spring washer 150. As shown in FIG. 3A, the spring washer 150 can possess a substantially circular-shaped body 152. Further, the spring washer 150 is configured to apply a clamping force between (a) the top electrode 108 (e.g., of the FPC 110, as also depicted in FIGS. 2C and 2D) and the cap portion 8 of the liquid lens 100, and (b) the bottom electrode 106 (e.g., of the FPC 110, as also depicted in FIGS. 2C and 2D) and the base portion 6 of the liquid lens 100. According to some embodiments of the liquid lens device 200, as shown in FIGS. 2C and 2D, the FPC 110 is folded over the liquid lens 100 such that the top electrode 108 and the bottom electrode 106 are in direct, electrical contact with the respective cap and base portions 8 and 6 of the liquid lens 100. In such embodiments, the spring washer 150 applies the clamping force to hold these components together, as illustrated in FIGS. 2A and 2B.

Referring again to FIGS. 2A and 2B, in some embodiments of the liquid lens device 200, the device further includes a housing 140, as shown in exemplary form in FIGS. 2A and 2B. The housing 140 can be configured to be in contact with the FPC 110 or the PCB (not shown) and one or both of the cap portion 8 and the base portion 6 of the liquid lens 100. In some embodiments of the liquid lens device 200, the housing 140 can be configured to be in contact (e.g., direct physical contact) with the FPC 100 or the PCB (not shown), without being in direct physical contact with the cap portion 8 and base portion 6 of the liquid lens 100. In these configurations, the spring washer 150 can also be configured to secure the housing 140 indirectly or directly to one or both of the cap portion 8 and the base portion 6 of the liquid lens 100.

In some embodiments of the liquid lens device 200 depicted in FIGS. 2A-2D, the clamping force of the spring washer 150 (see also FIG. 3A) can range from about 1 N to about 10 N, from about 1 N to about 7 N, from about 2 N to about 10 N, or from about 3 N to about 10 N. For example, the clamping force of the spring washer 150 can be 1 N, 2 N, 3 N, 4 N, 5 N, 6 N, 7 N, 8 N, 9 N, 10 N, and all clamping force values between the foregoing clamping force levels.

Referring now to FIGS. 3A-3C, the spring washer 150 employed in the liquid lens device 200 of the disclosure is configured with a substantially circular-shaped body 152. As would be understood by those of skill in the field of this disclosure, the body 152 of the spring washer 150 can vary in diameter, thickness (e.g., thickness 152a) and/or width, depending on the size of the liquid lens 100. Further, according to some embodiments, the spring washer 150 can be fabricated from a cold-worked, stainless steel alloy having a Vickers hardness of greater than 300 HV and an elongation of at least 20%. For example, the alloy employed for the spring washer 150 can have a Vickers hardness of at least 300 HV, 325 HV, 350 HV, 375 HV, 400 HV, and other minimum hardness levels between the foregoing hardness thresholds. As another example, the alloy employed for the spring washer 150 can be selected or otherwise cold-worked to have an elongation level of at least 20%, 21%, 22%, 23%, 24%, 25%, 27.5%, 30%, 35%, 40%, and all other minimum elongation levels between the foregoing levels. In some implementations, the spring washer 150 is fabricated from a stainless steel alloy, e.g., AISI 301 C1000, AISI 304 C1000, AISI 316 C1000, and AISI 631 C1000.

In some embodiments, as shown in FIGS. 3A-3C, the spring washer 150 is configured such that its body 152 includes a plurality of waves 154 in the thickness direction of the washer 150 (i.e., the axial direction of the liquid lens 100 shown in FIG. 1 along its optical axis (A)). Further, the waves 154 of the spring washer 150 can be adjusted in size, width and thickness to facilitate compression of the washer 150 during installation within the liquid lens device 200 and apply the clamping force to the liquid lens 100, as described above. According to an implementation of the spring washer 150, the plurality of waves 154 of the body 152 is at least 3 waves, with the waves spaced equidistantly from one another about the body 152. In other implementations, the plurality of waves 154 can range from 3 waves to twenty 20 waves, from 3 waves to ten 10 waves, or from 3 waves to 6 waves, and all numbers of waves between these numbers of waves.

Referring to the spring washer 150 depicted in FIGS. 3B and 3C, some implementations of the liquid lens device 200 (see FIGS. 2A-2D) can employ a washer 150 that further includes a plurality of lugs 156, with each lug 156 spaced between two of the waves 154. In embodiments, each lug 156 is spaced equidistantly between two of the waves 154 with a width 156b. Further, in some embodiments, each lug 156 includes a curved edge 157 with a radius 157a to facilitate installation within, or onto, a housing (e.g., housing 140 shown in FIGS. 2A and 2B). In embodiments, the housing 140 includes a plurality of tabs 146, and each of the lugs 156 is snapped onto a corresponding tab 146 to secure the housing 140 to one or both of the cap portion 8 and the base portion 6 of the liquid lens 100 (see FIGS. 2A and 2B).

Referring now to the spring washer 150 depicted in FIG. 4A, the waves 154 of the spring washer 150, as installed within the liquid lens device 200 (see FIGS. 2A and 2B), can be configured with a post-compression amplitude 154b in thickness direction, such that the post-compression amplitude 154b is from about 0.1 mm to about 0.5 mm, e.g., 0.1 mm, 0.15 mm, 0.20 mm, 0.25 mm, 0.3 mm, 0.35 mm, 0.4 mm, 0.45 mm, 0.5 mm, and all post-compression amplitudes between these levels. Similarly, the spring washer 150, as shown in FIG. 4B, can be installed within the liquid lens device 200 with a pre-compression amplitude 154a in the thickness direction, such that the pre-compression amplitude 154a is from about 0.4 mm to about 1.4 mm, from about 0.5 mm to about 1.2 mm, or from about 0.6 mm to about 1.0 mm. For example, the pre-compression amplitude 154a of the spring washer 150 can be set at about 0.4 mm, 0.5 mm, 0.6 mm, 0.7 mm, 0.8 mm, 0.9 mm, 1.0 mm, 1.1 mm, 1.2 mm, 1.3 mm, 1.4 mm, and all values between these pre-compression amplitude values.

Referring now to FIG. 5, a schematic, perspective view of a liquid lens device 200 is depicted with a printed circuit board (PCB) 130 and a spring washer 150 with a plurality of waves 154, according to an embodiment of the disclosure. In this configuration, the PCB 130 is further configured as a housing in contact with one or both of the cap portion 8 and the base portion 6 of the liquid lens 100 (see FIG. 1). In addition, the spring washer 150 is configured to secure the housing (i.e., PCB 130) to one or both of the cap portion 8 and the base portion 6 of the liquid lens 100. As shown in exemplary form in FIG. 5, the spring washer 150 is electrically connected to the top electrode 108 of the PCB 130 and the cap portion 8 of the liquid lens. As also shown in exemplary form in FIG. 5, bottom electrode 106 of the PCB 130 is in electrical contact with the base portion 6 of the liquid lens 100. In some embodiments, the PCB 130 is further fitted with a plurality of studs 132, with each stud 132 configured to provide mechanical support for the liquid lens 100 and the spring washer 150 and limit lateral movement of these components relative to the PCB 130.

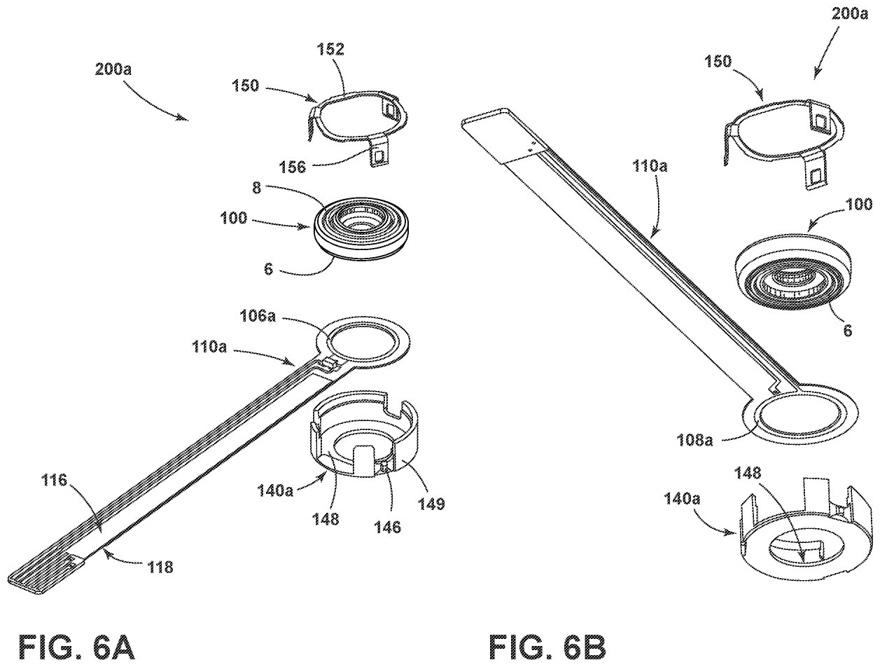

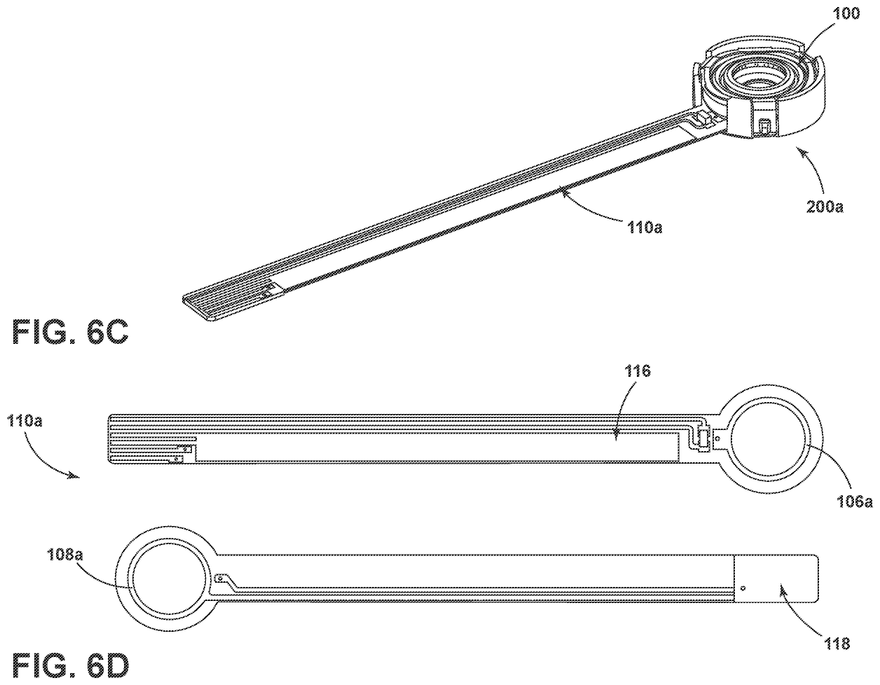

Referring now to FIGS. 6A and 6B, schematic, exploded perspective views of a liquid lens device 200a with an FPC 110a and a spring washer 150 are provided, according to an embodiment of the disclosure. The liquid lens device 200a shown in FIGS. 6A and 6B is similar to the liquid lens device 200 depicted in FIGS. 2A and 2B, and like-numbered elements have the same or substantially similar structures and functions, unless otherwise noted. For example, the liquid lens device 200a employs a liquid lens 100 (see FIG. 1) and a spring washer 150 (see FIGS. 3A-4B) that has a substantially circular-shaped body 152 made from an electrically conductive material (e.g., a metal alloy). In addition, the liquid lens device 200a further includes an FPC 110a with a top electrode 108a and a bottom electrode 106a (see also FIGS. 6C and 6D). As shown in FIGS. 6A and 6B, the bottom electrode 106a is in contact with the base portion 6 of the liquid lens 100. That is, as these elements are assembled the bottom electrode 106a can be placed in physical contact (e.g., direct physical contact) with the base portion 6 of the liquid lens 100 to make an electrical connection between these two elements. The liquid lens device 200a also includes a housing 140a that can be sized or otherwise configured to be in contact with one or both of the base portion 6 and the cap portion 8 of the liquid lens 100. As also shown, the top electrode 108a of the FPC 110a can be configured to be in physical contact (e.g., direct physical contact) with a top electrode contact portion 148 of the housing 140a (see FIG. 6B), e.g., to make an electrical connection between these two elements.

Referring again to the liquid lens device 200a depicted in FIGS. 6A and 6B, the spring washer 150 is configured to apply a clamping force (as described earlier in connection with the liquid lens device 200 shown in FIGS. 2A and 2B) between (a) the top electrode 108a and the top electrode contact portion 148 of the housing 140a, and (b) the bottom electrode 106a and the base portion 6 of the liquid lens 100. That is, the spring washer 150 (see also FIGS. 3A-4B) is configured to clamp these features together with a clamping force upon installation, e.g., as based in part on the pre-compression amplitude 154a and/or post-compression amplitude 154b of the waves 154 on the body 152 of the washer (see FIGS. 4A and 4B and corresponding description). In addition, the spring washer 150 in the liquid lens device 200a is configured to secure the housing 140a to the one or both of the cap portion 8 and the base portion 6 of the liquid lens 100 and maintain an electrical connection between the cap portion 8 of the liquid lens 100 and the top electrode contact portion 148 of the housing 140a. As to the former, the body 152 of the spring washer 150 can be installed in physical contact (e.g., direct physical contact) with the cap portion 8 of the liquid lens 100, and the lugs 156 of the washer 150 are secured in physical and electrical contact with the tabs 146 on the housing 140a, which is also in electrical contact with the top electrode contact portion 148 of the housing 140a. According to some embodiments of the liquid lens device 200a, the housing 140a is made from an electrically conductive material. According to other embodiments, the top electrode contact portion 148 of the housing 140a is electrically conductive. In some implementations, a remaining portion 149 of the housing 140a is anodized, oxidized or otherwise made from a non-conductive material. In such implementations, however, the top electrode contact portion 148 is in electrical contact with any portion of the housing 140a (e.g., the tabs 146) that are in physical and electrical contact with the spring washer 150, e.g., the lugs 156.

Referring now to FIGS. 6C and 6D, schematic, perspective views of the FPC 110a employed in the liquid lens device 200a (see FIGS. 6A and 6B) are provided. In some embodiments, the liquid lens device 200a is configured such that the FPC 110a possesses an upper face 116 and a lower face 118 that opposes the upper face 116. Further, the bottom electrode 106a is on the upper face 116 and the top electrode 108a is on the lower face 118. An advantage of this implementation is that the FPC 110a does not need to be folded over the liquid lens 100 to make electrical contact between the top and bottom electrodes 108a, 106a and the cap and base portions 8, 6 of the lens 100. For example, the FPC 110a can be free of a fold (e.g., between the top and bottom electrodes 108a, 106a). As such, the FPC 110a can use less material than conventional FPC designs, and the lack of a fold between the electrodes 108a, 106a can improve the overall reliability of the liquid lens device 200a.

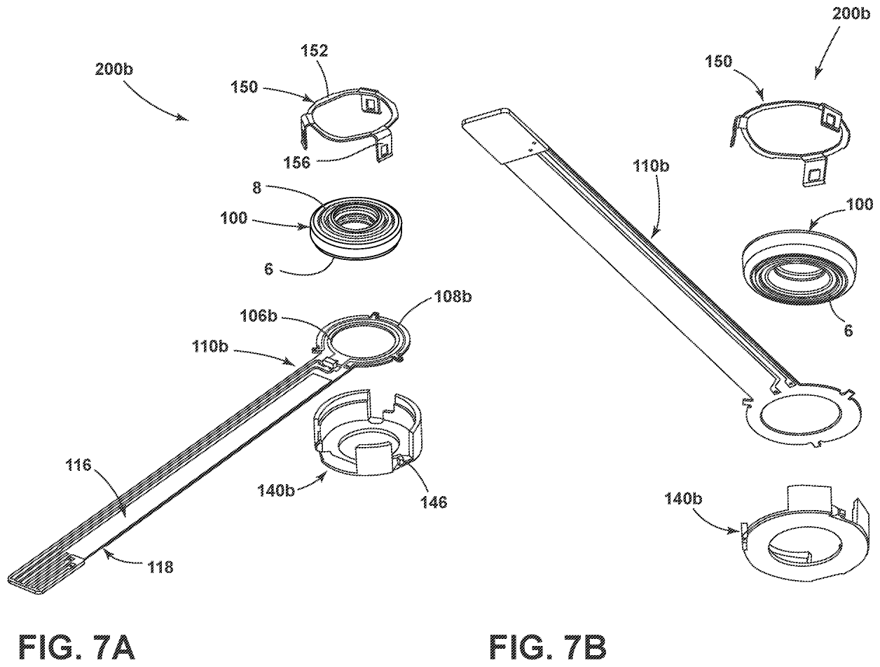

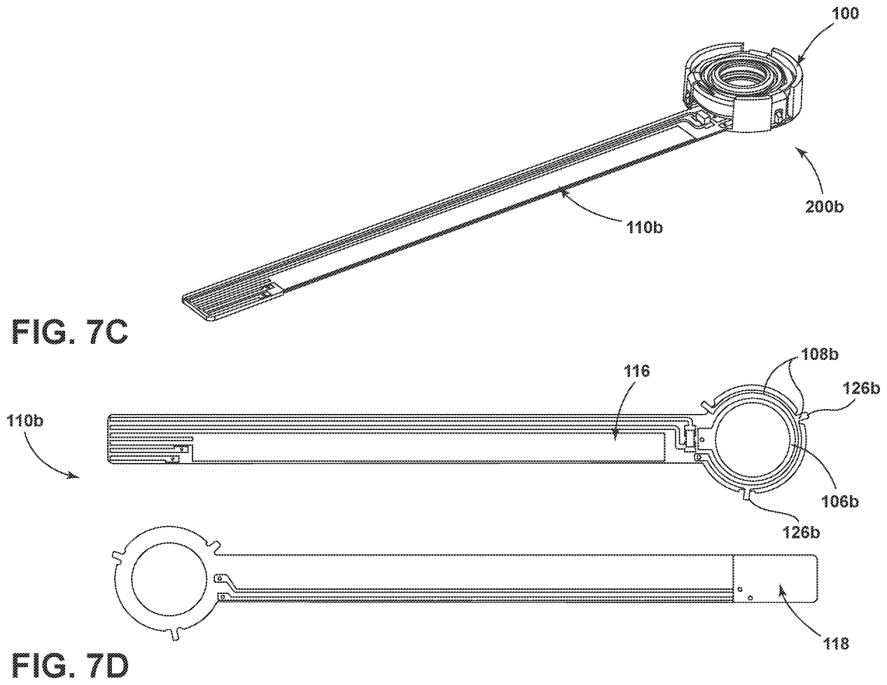

Referring now to FIGS. 7A and 7B, schematic, exploded perspective views of a liquid lens device 200b with an FPC 110b and a spring washer 150 are provided, according to an embodiment of the disclosure. The liquid lens device 200b shown in FIGS. 7A and 7B is similar to the liquid lens device 200 depicted in FIGS. 2A and 2B, and like-numbered elements have the same or substantially similar structures and functions, unless otherwise noted. For example, the liquid lens device 200b employs a liquid lens 100 (see FIG. 1) and a spring washer 150 (see FIGS. 3A-4B) that has a substantially circular-shaped body 152 made from an electrically conductive material (e.g., a metal alloy). In addition, the liquid lens device 200b further includes an FPC 110b with a top electrode 108b and a bottom electrode 106b (see also FIGS. 7C and 7D). As shown in FIGS. 7A and 7B, the bottom electrode 106b is in contact with the base portion 6 of the liquid lens 100. As these elements are assembled, the bottom electrode 106b can be placed in physical contact with the base portion 6 of the liquid lens 100 to make an electrical connection between these two elements. The liquid lens device 200b also includes a housing 140b that can be sized or otherwise configured to be in contact with one or both of the base portion 6 and the cap portion 8 of the liquid lens 100. As also shown, the top electrode 108b of the FPC 110b can be configured to be in physical contact with the spring washer 150, e.g., to make an electrical connection between these two elements.

Referring again to the liquid lens device 200b depicted in FIGS. 7A and 7B, the spring washer 150 is configured to apply a clamping force (as described earlier in connection with the liquid lens device 200 shown in FIGS. 2A and 2B) between (a) the top electrode 108b and the housing 140b, and (b) the bottom electrode 106b and the base portion 6 of the liquid lens 100. That is, the spring washer 150 (see also FIGS. 3A-4B) is configured to clamp these features together with a clamping force upon installation, e.g., as based in part on the pre-compression amplitude 154a and/or post-compression amplitude 154b of the waves 154 on the body 152 of the washer (see FIGS. 4A and 4B and corresponding description). In addition, the spring washer 150 in the liquid lens device 200b is configured to secure the housing 140b to one or both of the cap portion 8 and the base portion 6 of the liquid lens 100 and maintain an electrical connection between the cap portion 8 of the liquid lens 100 and the top electrode 108b of the FPC 110b. As to the former, the body 152 of the spring washer 150 can be installed in physical contact with the cap portion 8 of the liquid lens 100, and the lugs 156 of the washer 150 are secured in physical and electrical contact with the tabs 146 on the housing 140b, which is also in electrical contact with the top electrode 108b of the FPC 110b, e.g., at a plurality of tabs 126b (see FIG. 7D). According to some embodiments of the liquid lens device 200b depicted in FIGS. 7A and 7B, the housing 140b can be made from an electrically insulating material, e.g., as taking advantage of the direct electrical connection between the top electrode 108b of the FPC 110b, the spring washer 150 and the cap portion 8 of the liquid lens 100.

Referring now to FIGS. 7C and 7D, schematic, perspective views of the FPC 110b employed in the liquid lens device 200b (see FIGS. 7A and 7B) are provided. In some embodiments, the liquid lens device 200b is configured such that the FPC 110b possesses an upper face 116 and a lower face 118 that opposes the upper face 116. Further, each of the bottom electrode 106b and the top electrode 108b is on the upper face 116. An advantage of this implementation is that the FPC 110b does not need to be folded over the liquid lens 100 to make electrical contact between the top and bottom electrodes 108b, 106b and the cap and base portions 8, 6 of the lens 100. As such, the FPC 110b can use less material than conventional FPC designs and the lack of a fold between the electrodes 108b, 106b can improve the overall reliability of the liquid lens device 200b. In addition, the configuration of both electrodes on one face of the FPC 110b facilitates a direct electrical connection with the top electrode 108b and the spring washer 150, thus obviating the need for the housing 140b to be made from an electrically conductive material. In some implementations of the liquid lens device 200b, the top electrode 108b of the FPC 110b includes a plurality of tabs 126b and the spring washer 150 includes a plurality of lugs 156 (see FIGS. 3B and 3C). Further, each of the plurality of lugs 156 is snapped onto a corresponding tab 126b of the top electrode 108b of the FPC 110b to maintain an electrical connection between the top electrode 108b of the FPC 110b and the spring washer 150.

### EXAMPLES

Various embodiments will be further clarified by the following examples, which are exemplary of the articles of the disclosure.

### Example 1

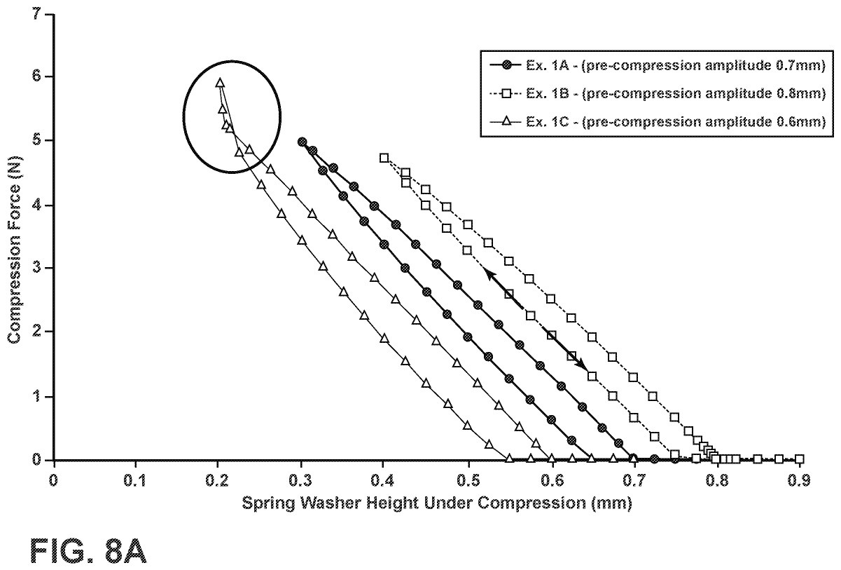

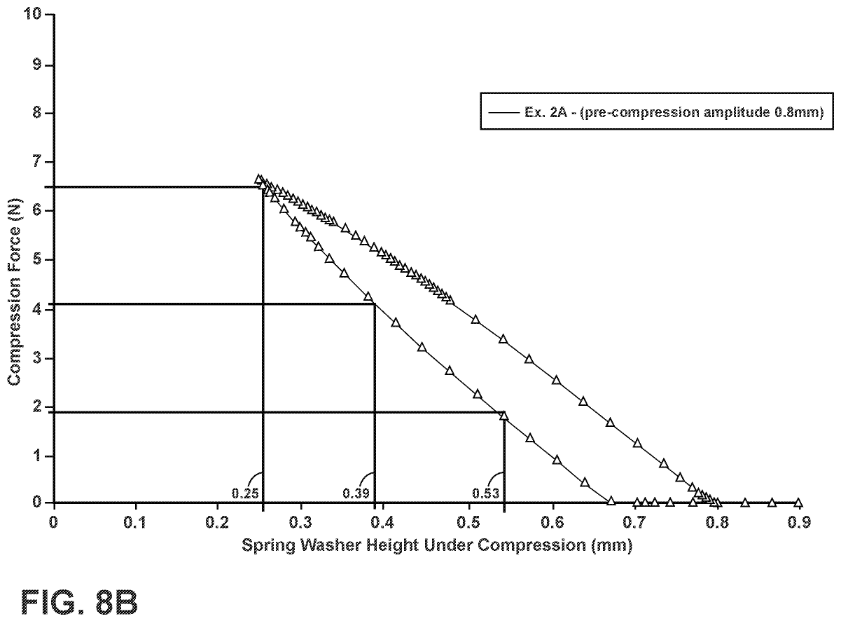

In this example, a simulation of liquid lens devices configured according to principles of the disclosure was conducted, as employing a spring washer with a plurality of waves having a finite pre-compression amplitude. In FIG. 8A, a schematic plot is provided of the compression force (N) vs. the pre-compression amplitude of the spring washer in each of these liquid lens devices. Further, the compression force (interchangeably referred to as a “clamping force” in this disclosure) was simulated for three sets of liquid lens devices, as configured with spring washers having a pre-compression amplitude of 0.7 mm (Ex. 1A), 0.8 mm (Ex. 1B) and 0.6 mm (Ex. 1C). As is evident from FIG. 8A, the liquid lens device with the spring washer having a pre-compression amplitude of 0.8 mm (Ex. 1B) can be compressed to a spring washer height (i.e., the wave amplitude) under compression of 0.4 mm (i.e., a compression rate of 50%), which results in a linear compression force vs. spring washer displacement (mm) such that 0.4 mm corresponds to a compression force of about 4.7 N and relaxation to 0.75 mm results in a compression force of 0 N. Similar results are observed in the liquid lens devices with the other spring washer pre-compression amplitudes (Ex. 1A and Ex. 1C).

### Example 2

In this example, a simulation of liquid lens devices configured according to principles of the disclosure was conducted, as employing a spring washer with a plurality of waves having a finite pre-compression amplitude. In FIG. 8B, a schematic plot is provided of the compression force (N) vs. the pre-compression amplitude of the spring washer in each of these liquid lens devices. Further, the compression force was simulated for one set of liquid lens devices, as configured with a spring washer having a pre-compression amplitude of 0.8 mm (Ex. 2A). As is evident from FIG. 8B, the liquid lens device with the spring washer having a pre-compression amplitude of 0.8 mm (Ex. 2A) can be compressed to a spring washer height (i.e., the wave amplitude) under compression of about 0.25 mm (i.e., a compression rate of 70%), which results in a linear compression force vs. spring washer height (mm) such that 0.25 mm corresponds to a compression force of about 6.5 N, relaxation to 0.39 mm corresponds to a compression force of 4.1 N, and relaxation to 0.53 mm corresponds to a compression force of about 1.9 N. In such a configuration, the liquid lens device could be compatible with a total stack tolerance of +/−0.14 mm (from 0.25 mm to 0.53 mm) with a nominal compression of about 4.1 N at a spring washer height/amplitude of 0.39 mm.

Variations and modifications may be made to the above-described embodiments of the disclosure without departing substantially from the spirit and various principles of the disclosure. All such modifications and variations are intended to be included herein within the scope of this disclosure and protected by the following claims. For example, the various features of the disclosure may be combined according to the following embodiments.

Embodiment 1. According to a first embodiment, a liquid lens device is provided. The liquid lens device comprises: a liquid lens that comprises: first and second immiscible fluids 12a, 12b defining an interface moveable by electrowetting, a cap portion, a base portion, a gasket positioned between the cap portion and the base portion, an upper window positioned within the cap portion, and a lower window positioned within the base portion, wherein the windows are facing and substantially parallel to each other and the fluids 12a, 12b are sealed within the cap portion, base portion, gasket and windows; a flexible printed circuit (FPC) or a printed circuit board (PCB) comprising a top electrode and a bottom electrode in electrical contact with the respective cap portion and base portion of the liquid lens; and a spring washer comprising a substantially circular-shaped body, wherein the spring washer is configured to apply a clamping force between (a) the top electrode and the cap portion of the liquid lens, and (b) the bottom electrode and the base portion of the liquid lens. Further, the clamping force of the spring washer is from about 1 N to about 10 N.

Embodiment 2. According to a second embodiment, the first embodiment is provided, comprising: a housing in contact with the FPC or PCB, wherein the spring washer is also configured to secure the housing to the one or both of the cap portion and the base portion of the liquid lens.

Embodiment 3. According to a third embodiment, the first embodiment is provided, wherein the PCB is further configured as a housing in contact with one or both of the cap portion and the base portion of the liquid lens, and further wherein the spring washer is also configured to secure the housing to the one or both of the cap portion and the base portion of the liquid lens.

Embodiment 4. According to a fourth embodiment, any one of the first through third embodiments is provided, wherein the clamping force of the spring washer is from about 1 N to about 7 N.

Embodiment 5. According to a fifth embodiment, any one of the first through fourth embodiments is provided, wherein the body of the spring washer comprises a plurality of waves in a thickness direction.

Embodiment 6. According to a sixth embodiment, the fifth embodiment is provided, wherein the plurality of waves of the body of the spring washer is at least three (3) waves spaced equidistantly from one another.

Embodiment 7. According to a seventh embodiment, the fifth or sixth embodiment is provided, wherein the plurality of waves of the spring washer comprises a pre-compression amplitude in the thickness direction, and further wherein the pre-compression amplitude is from about 0.4 mm to about 1.4 mm.

Embodiment 8. According to an eighth embodiment, the seventh embodiment is provided, wherein the plurality of waves of the spring washer comprises a post-compression amplitude in the thickness direction, and further wherein the post-compression amplitude is from about 0.1 mm to about 0.5 mm.

Embodiment 9. According to a ninth embodiment, any one of the fifth through eighth embodiments is provided, wherein the spring washer further comprises a plurality of lugs, each lug spaced between two of the waves, wherein the housing comprises a plurality of tabs, and further wherein each of the plurality of lugs is snapped onto a corresponding tab of the plurality of tabs to secure the housing to the one or both of the cap portion and the base portion.

Embodiment 10. According to a tenth embodiment, any one of the first through ninth embodiments is provided, wherein the spring washer comprises a cold-worked, stainless steel alloy having a Vickers hardness of greater than 300 HV and an elongation of at least 20%.

Embodiment 11. According to an eleventh embodiment, a liquid lens device is provided. The liquid lens device comprises: a liquid lens that comprises: first and second immiscible fluids defining an interface moveable by electrowetting, a cap portion, a base portion, a gasket positioned between the cap portion and the base portion, an upper window positioned within the cap portion, and a lower window positioned within the base portion, wherein the windows are facing and substantially parallel to each other and the fluids are sealed within the cap portion, base portion, gasket and windows; a flexible printed circuit (FPC) comprising a top electrode and a bottom electrode, wherein the bottom electrode is in contact with the base portion of the liquid lens; a housing in contact with one or both of the base portion and the cap portion of the liquid lens, wherein the top electrode of the FPC is in contact with a top electrode contact portion of the housing; and a spring washer comprising a substantially circular-shaped body made from an electrically conductive material, wherein the spring washer is configured to apply a clamping force between (a) the top electrode and the top electrode contact portion of the housing, and (b) the bottom electrode and the base portion of the liquid lens, and further wherein the spring washer is also configured to secure the housing to the one or both of the cap portion and the base portion of the liquid lens and maintain an electrical connection between the cap portion of the liquid lens and the top electrode contact portion of the housing. Further, the clamping force of the spring washer is from about 1 N to about 10 N.

Embodiment 12. According to a twelfth embodiment, the eleventh embodiment is provided, wherein the FPC comprises an upper face and a lower face that opposes the upper face, wherein the bottom electrode is on the upper face and the top electrode is on the lower face.

Embodiment 13. According to a thirteenth embodiment, the twelfth embodiment is provided, wherein the housing is made from an electrically conductive material.

Embodiment 14. According to a fourteenth embodiment, the twelfth embodiment is provided, wherein the top electrode contact portion of the housing is electrically conductive.

Embodiment 15. According to a fifteenth embodiment, the fourteenth embodiment is provided, wherein a remaining portion of the housing is anodized or oxidized.

Embodiment 16. According to a sixteenth embodiment, any one of the eleventh through fifteenth embodiments is provided, wherein the clamping force of the spring washer is from about 1 N to about 7 N.

Embodiment 17. According to a seventeenth embodiment, any one of the eleventh through sixteenth embodiments is provided, wherein the body of the spring washer comprises a plurality of waves in a thickness direction.

Embodiment 18. According to an eighteenth embodiment, the seventeenth embodiment is provided, wherein the plurality of waves of the body of the spring washer is at least three (3) waves spaced equidistantly from one another.

Embodiment 19. According to a nineteenth embodiment, the seventeenth or eighteenth embodiment is provided, wherein the plurality of waves of the spring washer comprises a pre-compression amplitude in the thickness direction, and further wherein the pre-compression amplitude is from about 0.4 mm to about 1.4 mm.

Embodiment 20. According to a twentieth embodiment, the nineteenth embodiment is provided, wherein the plurality of waves of the spring washer comprises a post-compression amplitude in the thickness direction, and further wherein the post-compression amplitude is from about 0.1 mm to about 0.5 mm.

Embodiment 21. According to a twenty-first embodiment, a liquid lens device is provided. The liquid lens device comprises: a liquid lens that comprises: first and second immiscible fluids defining an interface moveable by electrowetting, a cap portion, a base portion, a gasket positioned between the cap portion and the base portion, an upper window positioned within the cap portion, and a lower window positioned within the base portion, wherein the windows are facing and substantially parallel to each other and the fluids are sealed within the cap portion, base portion, gasket and windows; a flexible printed circuit (FPC) comprising a top electrode and a bottom electrode, wherein the bottom electrode is in contact with the base portion of the liquid lens; a housing in contact with one or both of the base portion and the cap portion of the liquid lens; and a spring washer comprising a substantially circular-shaped body made from an electrically conductive material, wherein the top electrode of the FPC is in contact with the spring washer, wherein the spring washer is configured to apply a clamping force between (a) the top electrode and the housing, and (b) the bottom electrode and the base portion of the liquid lens, and further wherein the spring washer is also configured to secure the housing to the one or both of the cap portion and the base portion of the liquid lens and maintain an electrical connection between the cap portion of the liquid lens and the top electrode of the FPC. The clamping force of the spring washer is from about 1 N to about 10 N.

Embodiment 22. According to a twenty-second embodiment, the twenty-first embodiment is provided, wherein the FPC comprises an upper face and a lower face that opposes the upper face, wherein each of the bottom electrode and the top electrode is on the upper face.

Embodiment 23. According to a twenty-third embodiment, the twenty-second embodiment is provided, wherein the housing is made from an electrically insulating material.

Embodiment 24. According to a twenty-fourth embodiment, any one of the twenty-first through twenty-third embodiment is provided, wherein the top electrode of the FPC comprises a plurality of tabs and the spring washer further comprises a plurality of lugs, and further wherein each of the plurality of lugs is snapped onto a corresponding tab of the top electrode of the FPC to maintain an electrical connection between the top electrode of the FPC and the spring washer.

Embodiment 25. According to a twenty-fifth embodiment, any one of the twenty-first through twenty-fourth embodiments is provided, wherein the clamping force of the spring washer is from about 1 N to about 7 N.

Embodiment 26. According to a twenty-sixth embodiment, any one of the twenty-first through twenty-fifth embodiments is provided, wherein the body of the spring washer comprises a plurality of waves in a thickness direction.

Embodiment 27. According to a twenty-seventh embodiment, the twenty-sixth embodiment is provided, wherein the plurality of waves of the body of the spring washer is at least three (3) waves spaced equidistantly from one another.

Embodiment 28. According to a twenty-eighth embodiment, the twenty-sixth or twenty-seventh embodiment is provided, wherein the plurality of waves of the spring washer comprises a pre-compression amplitude in the thickness direction, and further wherein the pre-compression amplitude is from about 0.4 mm to about 1.4 mm.

Embodiment 29. According to a twenty-ninth embodiment, the twenty-eighth embodiment is provided, wherein the plurality of waves of the spring washer comprises a post-compression amplitude in the thickness direction, and further wherein the post-compression amplitude is from about 0.1 mm to about 0.5 mm.

What is claimed is:

1. A liquid lens device, comprising:
a liquid lens that comprises:
first and second immiscible fluids defining an interface moveable by electrowetting,
a cap portion,
a base portion,
a gasket positioned between the cap portion and the base portion,
an upper window positioned within the cap portion, and
a lower window positioned within the base portion, wherein the windows are facing and substantially parallel to each other and the fluids are sealed within the cap portion, base portion, gasket and windows;
a flexible printed circuit (FPC) or a printed circuit board (PCB) comprising a top electrode and a bottom electrode in electrical contact with the respective cap portion and base portion of the liquid lens; and
a spring washer comprising a substantially circular-shaped body,
wherein the spring washer is configured to apply a clamping force between (a) the top electrode and the cap portion of the liquid lens, and (b) the bottom electrode and the base portion of the liquid lens, and
further wherein the clamping force of the spring washer is from about 1 N to about 10 N.

2. The device according to claim 1, further comprising:
a housing in contact with the FPC or PCB,
wherein the spring washer is also configured to secure the housing to the one or both of the cap portion and the base portion of the liquid lens.

3. The device according to claim 1, wherein the PCB is further configured as a housing in contact with one or both of the cap portion and the base portion of the liquid lens, and further wherein the spring washer is also configured to secure the housing to the one or both of the cap portion and the base portion of the liquid lens.

4. The device according to any one of claims 1-3, wherein the clamping force of the spring washer is from about 1 N to about 7 N.

5. The device according to any one of claims 1-4, wherein the body of the spring washer comprises a plurality of waves in a thickness direction.

6. The device according to claim 5, wherein the plurality of waves of the body of the spring washer is at least three (3) waves spaced equidistantly from one another.

7. The device according to claim 5 or claim 6, wherein the plurality of waves of the spring washer comprises a pre-compression amplitude in the thickness direction, and further wherein the pre-compression amplitude is from about 0.4 mm to about 1.4 mm.

8. The device according to claim 7, wherein the plurality of waves of the spring washer comprises a post-compression amplitude in the thickness direction, and further wherein the post-compression amplitude is from about 0.1 mm to about 0.5 mm.

9. The device according to any one of claims 5-8, wherein the spring washer further comprises a plurality of lugs, each lug spaced between two of the waves, wherein the housing comprises a plurality of tabs, and further wherein each of the plurality of lugs is snapped onto a corresponding tab of the plurality of tabs to secure the housing to the one or both of the cap portion and the base portion.

10. The device according to any one of claims 1-9, wherein the spring washer comprises a cold-worked, stainless steel alloy having a Vickers hardness of greater than 300 HV and an elongation of at least 20%.

11. A liquid lens device, comprising:
a liquid lens that comprises:
first and second immiscible fluids defining an interface moveable by electrowetting,
a cap portion,
a base portion,
a gasket positioned between the cap portion and the base portion,
an upper window positioned within the cap portion, and
a lower window positioned within the base portion, wherein the windows are facing and substantially parallel to each other and the fluids are sealed within the cap portion, base portion, gasket and windows;
a flexible printed circuit (FPC) comprising a top electrode and a bottom electrode, wherein the bottom electrode is in contact with the base portion of the liquid lens;
a housing in contact with one or both of the base portion and the cap portion of the liquid lens, wherein the top electrode of the FPC is in contact with a top electrode contact portion of the housing; and
a spring washer comprising a substantially circular-shaped body made from an electrically conductive material,
wherein the spring washer is configured to apply a clamping force between (a) the top electrode and the top electrode contact portion of the housing, and (b) the bottom electrode and the base portion of the liquid lens,
wherein the clamping force of the spring washer is from about 1 N to about 10 N, and
further wherein the spring washer is also configured to secure the housing to the one or both of the cap portion and the base portion of the liquid lens and maintain an electrical connection between the cap portion of the liquid lens and the top electrode contact portion of the housing.

12. The device according to claim 11, wherein the FPC comprises an upper face and a lower face that opposes the upper face, wherein the bottom electrode is on the upper face and the top electrode is on the lower face.

13. The device according to claim 12, wherein the housing is made from an electrically conductive material.

14. The device according to claim 12, wherein the top electrode contact portion of the housing is electrically conductive.

15. The device according to claim 14, wherein a remaining portion of the housing is anodized or oxidized.

16. The device according to any one of claims 11-15, wherein the clamping force of the spring washer is from about 1 N to about 7 N.

17. The device according to any one of claims 11-16, wherein the body of the spring washer comprises a plurality of waves in a thickness direction.

18. The device according to claim 17, wherein the plurality of waves of the body of the spring washer is at least three (3) waves spaced equidistantly from one another.

19. The device according to claim 17 or claim 18, wherein the plurality of waves of the spring washer comprises a pre-compression amplitude in the thickness direction, and further wherein the pre-compression amplitude is from about 0.4 mm to about 1.4 mm.

20. The device according to claim 19, wherein the plurality of waves of the spring washer comprises a post-compression amplitude in the thickness direction, and further wherein the post-compression amplitude is from about 0.1 mm to about 0.5 mm.

21. A liquid lens device, comprising:
a liquid lens that comprises:
first and second immiscible fluids defining an interface moveable by electrowetting,
a cap portion,
a base portion,
a gasket positioned between the cap portion and the base portion,
an upper window positioned within the cap portion, and
a lower window positioned within the base portion, wherein the windows are facing and substantially parallel to each other and the fluids are sealed within the cap portion, base portion, gasket and windows;
a flexible printed circuit (FPC) comprising a top electrode and a bottom electrode, wherein the bottom electrode is in contact with the base portion of the liquid lens;
a housing in contact with one or both of the base portion and the cap portion of the liquid lens; and
a spring washer comprising a substantially circular-shaped body made from an electrically conductive material,
wherein the top electrode of the FPC is in contact with the spring washer,
wherein the spring washer is configured to apply a clamping force between (a) the top electrode and the housing, and (b) the bottom electrode and the base portion of the liquid lens,
wherein the clamping force of the spring washer is from about 1 N to about 10 N, and
further wherein the spring washer is also configured to secure the housing to the one or both of the cap portion and the base portion of the liquid lens and maintain an electrical connection between the cap portion of the liquid lens and the top electrode of the FPC.

22. The device according to claim 21, wherein the FPC comprises an upper face and a lower face that opposes the upper face, wherein each of the bottom electrode and the top electrode is on the upper face.

23. The device according to claim 22, wherein the housing is made from an electrically insulating material.

24. The device according to any one of claims 21-23, wherein the top electrode of the FPC comprises a plurality of tabs and the spring washer further comprises a plurality of lugs, and further wherein each of the plurality of lugs is snapped onto a corresponding tab of the top electrode of the FPC to maintain an electrical connection between the top electrode of the FPC and the spring washer.

25. The device according to any one of claims 21-24, wherein the clamping force of the spring washer is from about 1 N to about 7 N.

26. The device according to any one of claims 21-25, wherein the body of the spring washer comprises a plurality of waves in a thickness direction.

27. The device according to claim 26, wherein the plurality of waves of the body of the spring washer is at least three (3) waves spaced equidistantly from one another.

28. The device according to claim 26 or claim 27, wherein the plurality of waves of the spring washer comprises a pre-compression amplitude in the thickness direction, and further wherein the pre-compression amplitude is from about 0.4 mm to about 1.4 mm.

29. The device according to claim 28, wherein the plurality of waves of the spring washer comprises a post-compression amplitude in the thickness direction, and further wherein the post-compression amplitude is from about 0.1 mm to about 0.5 mm.
